(19) United States
(12) Patent Application Publication
(10) Pub. No.: US 2017/0120449 A1
(43) Pub. Date: May 4, 2017

(54) SIMULATION APPARATUS OF ROBOT, SIMULATION METHOD OF ROBOT, CONTROL UNIT AND ROBOT SYSTEM

(71) Applicant: MITSUBISHI HEAVY INDUSTRIES, LTD., Tokyo (JP)

(72) Inventors: Natsuki MATSUNAMI, Tokyo (JP); Tomohiro TAMI, Tokyo (JP); Naoto KAWAUCHI, Tokyo (JP)

(21) Appl. No.: 15/117,800

(22) PCT Filed: Feb. 27, 2015
(86) PCT No.: PCT/JP2015/055929

§ 371 Date: Aug. 10, 2016

(30) Foreign Application Priority Data
Mar. 14, 2014 (JP) 2014-052546

(51) Int. Cl. B25J 9/16; B25J 9/04

(52) U.S. Cl. CPC B25J 9/1671; B25J 9/046; B25J 9/1676; G05B 2219/40314; G05B 2219/40373; G05B 2219/40495; G05B 2219/40317

(57) ABSTRACT

A movable range of angle of each of the plurality of joints and a safety region defined within the movable range are set. An angle command value is generated to each of the plurality of joints, based on current angle data and a distal end position command value. A fault avoidance control is carried out to make a change rate of the angle command value small, when the angle command value is generated to either of the plurality of joints, and the angle command value of the joint exceeds the safety region.

### TECHNICAL FIELD

The present invention relates to a control of a robot having a multi-joint manipulator.

### BACKGROUND ART

A robot having a multi-joint manipulator (a multi-joint arm) is known. FIG. 1 shows a reference example of the multi-joint manipulator. The multi-joint manipulator 101 has a plurality of links L101 to L106 which are connected in series. The neighbor links (e.g. links L101 and L102) are connected through a joint (joint J102) to be movable. In an example of FIG. 1, the multi-joint manipulator 101 is shown to have six rotation joints (joints J101 to J106).

Specifically, one end of a supporting section 103 is attached to a fixed base section 102. One side of a first joint J101 is attached to the other end of the supporting section 103. One end of the first link L101 is attached to the other side of the first joint J101. One side of a second joint J102 is attached to the other end of the first link L101. Hereinafter, in the same way, one side of a sixth joint J106 is attached to the other end of a fifth link L105. One end of the sixth link L106 is attached to the other side of the sixth joint J106. An end effector 104 is attached to the other end of the link L106.

An operator specifies a position of the distal end (a position of the tip of the end effector and so on) in the world coordinate system (as a position command value) to a control device. The control device calculates an angle command value of each of the joints J101 to J106 by inverse kinematics calculation, so that the distal end moves to a direction of a position command value. Each of the joints J101 to J106 is driven by a motor and so on in response to the angle command value. Through such a control, the distal end of the multi-joint manipulator 101 can be moved to a desired position.

As a position control method of a robot, Non-Patent Literature 1 describes a linear feedback control method and a method using a 2-step control of linearization and servo compensation.

### CITATION LIST

[Non-Patent Literature 1] “Foundation of Robot Control”, (Tsuneo Kikkawa), corona Inc., Published on Nov. 25, 1988

### SUMMARY OF THE INVENTION

In some embodiments, a simulation apparatus is a simulation apparatus for a multi-joint manipulator having a plurality of joints. The simulation apparatus has a storing section configured to store a movable range of angle of each of the plurality of joints and a safety region defined within the movable range in a storage unit; and a processing unit as an angle command value calculating section. The angle command calculating section generates an angle command value for each of the plurality of joints, based on current angle data indicating a current angle of each of the plurality of joints and a distal end position command value of the multi-joint manipulator. The angle command value calculating section carries out a fault avoidance control to make a change rate of the angle command value small, when the angle command value is generated to a stop joint candidacy which is either of the plurality of joints and the angle command value of which exceeds the safety region.

In some embodiments, a simulation method is a simulation method of a multi-joint manipulator having a plurality of joints. The simulation method includes storing in a storage unit, a movable range of angle of each of the plurality of joints and a safety region defined within the movable range; and generating, by a processing unit, an angle command value of each of the plurality of joints based on current angle data indicating current angle of each of the plurality of joints and a distal end position command value of the multi-joint manipulator. The generating the angle command value includes carrying out a fault avoidance control to make a change rate of the angle command value small, when the angle command value is generated to a stop joint candidacy which is either of the plurality of joints and the angle command value of which exceeds the safety region.

By the present invention, the technique which relaxes the restriction of movement in the movable range of the joint in the control of the multi-joint manipulator is provided.

### BRIEF DESCRIPTION OF THE DRAWINGS

The attached drawings are incorporated into the Specification to help the description of embodiments. Note that the drawings should not be interpreted to limit the present invention to examples shown in the Drawings and described.

FIG. 1 shows a reference example of a multi-joint manipulator.

FIG. 2 shows a reference example of the multi-joint manipulator.

FIG. 3 shows time changes of angle command values of a joint.

FIG. 4 shows a robot system.

FIG. 5 is a diagram showing a calculation in case of control of a joint.

FIG. 6 shows a time change of an angle command value of a joint.

FIG. 7 shows the time change of the angle command value of a joint.

FIG. 8 shows functional blocks which are realized by a computer.

FIG. 9 shows a safety region table.

FIG. 10 is a flow chart of a fault avoidance control.

FIG. 11 shows a data table.

FIG. 12 is a diagram showing a simulation calculation of the multi-joint manipulator.

FIG. 13 shows an example of a multi-joint manipulator image.

FIG. 14 is a flow chart of trajectory correction processing.

FIG. 15 shows an example of the multi-joint manipulator image.

FIG. 16 is a flow chart of through-point setting processing.

FIG. 17 is a diagram of a method of setting the through-point.

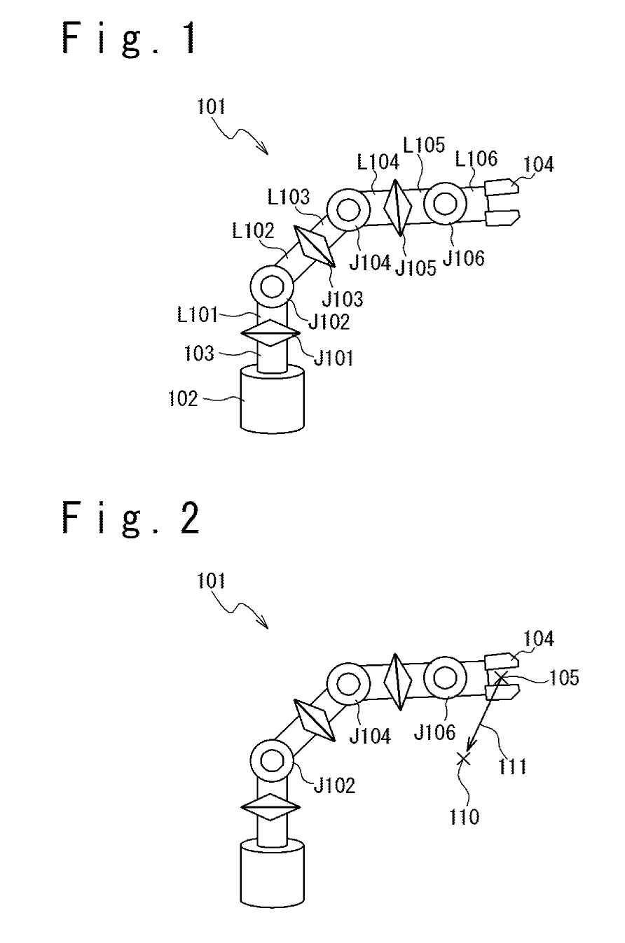

### DESCRIPTION OF EMBODIMENTS

### Matters Having Recognized by the Inventors

FIG. 2 shows a multi-joint manipulator 101 as a reference example. It is supposed to move a distal end 105 to a target point 110. When the operator inputs the target point 110, a control unit calculates a command value of a joint angle for the distal end 105 to move to the target point 110. Each joint is driven for the distal end 105 to reach the target point 110 according to the command value. A trajectory 111 which the distal end 105 draws in case of this operation is shown in FIG. 2.

In such a control, the control unit gives a command value of position and attitude of the distal end 105, and a command value of angle of each joint is calculated through the inverse kinematics based on the command value. The multi-joint manipulator 101 is driven based on the command value of each of the joint angles.

In the inverse kinematics calculation of calculating each joint angle, when the Jacobian matrix is used that gives a relation of a distal end velocity and a joint angular velocity, the command value can be calculated easily and systematically. In this case, by integrating the joint angular velocity which is calculated using the Jacobian matrix, with respect to time, a command value of angle change (variation of angle) δθ of each joint is calculated. By adding the command value of the angle change δθ and a current value of angle of the joint, a command value of angle of the joint is obtained.

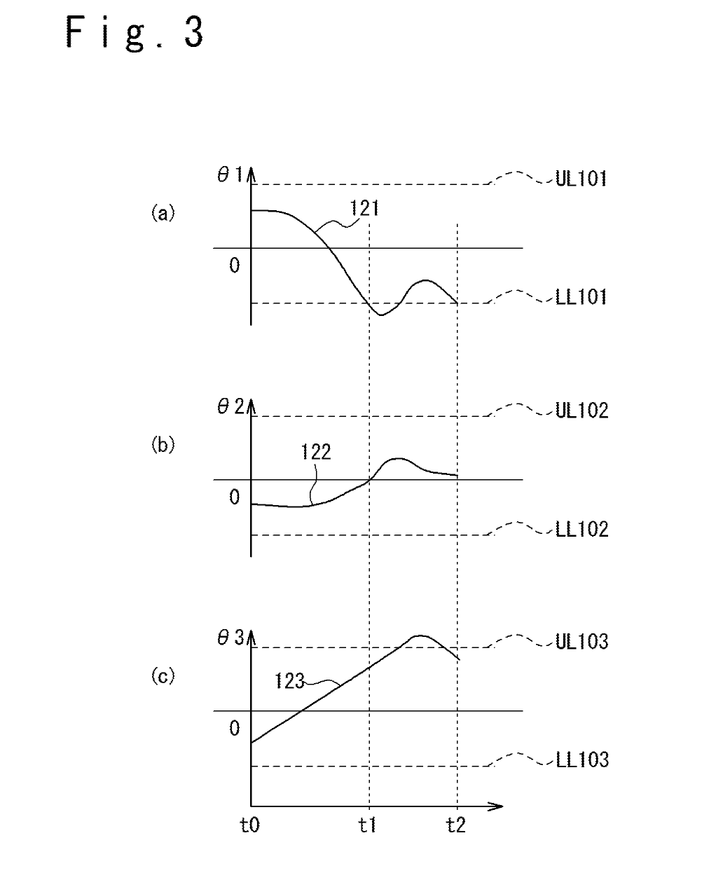

Next, a problem that could be caused in case of calculating the command value in this way will be described. To simplify the description, it is supposed that only three joints J102, J104, and J106 are driven in the multi-joint manipulator 101 of FIG. 2. FIG. 3 shows examples of the angles of the joints J102, J104 and J106 calculated in the above-mentioned method when the distal end 105 moves to show the trajectory 111. The horizontal line of FIG. 3 shows time. An angle 121 shown by a curve in (a) of FIG. 3 shows a time change of angle θ1 of the joint J102. An angle 122 shown by a curve in (b) of FIG. 3 shows a time change of angle θ2 of the joint J104. An angle 123 shown by a curve in (c) of FIG. 3 shows a time change of angle θ3 of the joint J106.

When a movable range of each of the joints J102, J104, and J106 of the multi-joint manipulator 101 is narrow, there is a possibility that it is difficult that the distal end 105 approaches a target point 110. The movable range of each of the joints J102, J104, and J106 is shown in FIG. 3. The angle θ1 of the joint J102 is movable in a range between a lower limit value LL101 and an upper limit value UL101 and it is supposed not to be able to exceed the range. In the same way, the angle θ2 of the joint J104 is movable in a range between a lower limit value LL102 and an upper limit value UL102 and the angle θ3 of the joint J106 is movable in a range between a lower limit value LL103 and an upper limit value UL103.

In an example of FIG. 3, the angle θ1 of the joint J102 falls below the lower limit value LL101 at time t1. Therefore, even if the joint angle is calculated in accordance with forward kinematics calculation and inverse kinematics calculation to reach the target point 110, the angle of the joint J102 exceeds the movable range at time t1. In such a case, it is ordinary to provide an interlock to stop an operation at the time. Therefore, when the multi-joint manipulator 101 is controlled while the calculation of the forward kinematics and the inverse kinematics using the Jacobian matrix is carried out in a realtime, the movement of the joint has stopped at time t1.

In an example of FIG. 3, when it is supposed that there is no limitation in the movable ranges of the joints J102, J104, and J106, the angles θ1 to θ3 of all the joints fall within the movable ranges at time t2 when the distal end 105 reaches the target point 110. That is, although the command value of joint angle exceeds the movable range once, the angle of each of the joints J102, J104, and J106 falls within the movable range in the attitude of the multi-joint manipulator 101 when the distal end 105 has reached the target point 110. Therefore, if the trajectory 111 on the way is different, there is a possibility that the distal end 105 could be moved to the target point 110.

Note that FIG. 2 and FIG. 3 are diagrams used to describe the matters recognized by the inventors. Therefore, FIG. 2 and FIG. 3 do not show any conventional technique before the application of the present invention.

Hereinafter, embodiments will be described with reference to the attached drawings. Many specific items are disclosed for the purpose of the description in the following detailed description to provide the comprehensive understanding of the embodiments. However, it would be apparent that one or plural embodiments can be implemented without these detailed specific items.

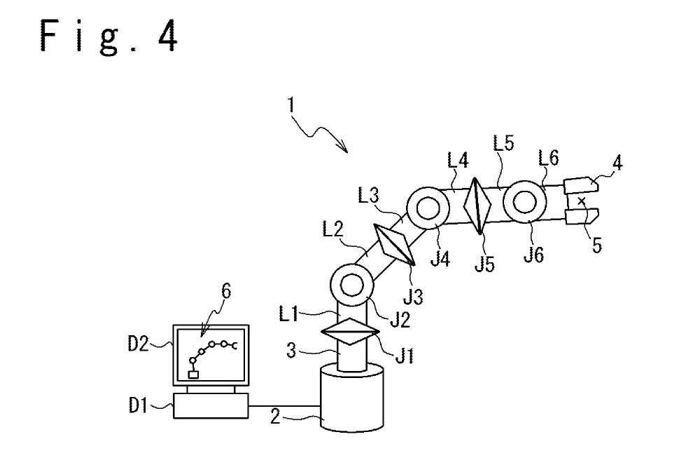

FIG. 4 shows a robot system which includes a multi-joint manipulator 1, a computer D1 and a display device D2 in an embodiment. The multi-joint manipulator 1 has a base section 2 fixed on a floor surface and so on. One end of a supporting section 3 is fixed on the base section 2. When the base section 2 can be moved by a cart and so on, the following description can be applied in the same way if a coordinate transformation is executed to the movement.

The other end of the supporting section 3 is fixed on one side of a joint J1. One end of a first link L1 is attached to the other side of the first joint J1. One side of a second joint J2 is attached to the other end of the first link L1. Hereinafter, in the same way, the connection is repeated, and one side of a sixth joint J6 is attached to the other end of a fifth link L5. One end of a sixth link L6 is attached to the other side of the sixth joint J6. An end effector 4 is attached to the other end of the sixth link L6. In an example of FIG. 4, the multi-joint manipulator 1 having six joints J1 to J6 is shown. However, the multi-joint manipulator 1 having n degrees of freedom and composed of n joints J1 to Jn (n is a natural number equal to or more than 1) may be used, and n may be more or fewer than the above case.

The operator specifies and outputs to the control unit, a position command value indicating a desired position (a movement target position) in the world coordinate system and an attitude command value (a final target value) indicating a desired attitude (a target attitude) of the distal end 5 set at the tip of the end effector 4 of the multi-joint manipulator 1 and so on. The control unit generates an angle command value for each of the joints J1 to J6 for the distal end 5 to head for a state specified by the position command value and the attitude command value. Each of the joints J1 to J6 is driven by a motor and so on in response to the angle command value. Through such a control, the distal end 5 of the multi-joint manipulator 1 can be moved to the desired position.

The computer D1 is connected with the multi-joint manipulator 1. The computer D1 has a non-transitory recording medium (a storage unit) such as a hard disk and a processing unit which contains a hardware processor. The computer D1 (more specifically, the processing unit of the computer) executes a software program stored in the recording medium so that the state or operation of the multi-joint manipulator 1 can be virtually displayed on the display device D2 (simulation display). The operator can confirm the state and operation of the multi-joint manipulator 1 previously on the screen of the display device D2 through the simulation. The operator can see a multi-joint manipulator image 6 displayed on the screen and moves the distal end 5 on the screen to a desired place by Graphical User Interface such as a pointer and specifies the attitude of the distal end 5. By such a screen operation, the position command value and attitude command value of the distal end 5 of the multi-joint manipulator 1 can be set.

By the computer D1 (or the computer D1 and the display device D2), a simulation apparatus which carries out simulation of the multi-joint manipulator 1, a control data generation apparatus of the multi-joint manipulator 1 and a control unit of the multi-joint manipulator 1 are realized. A robot system is configured from the computer D1, the display device D2 and the multi-joint manipulator 1.

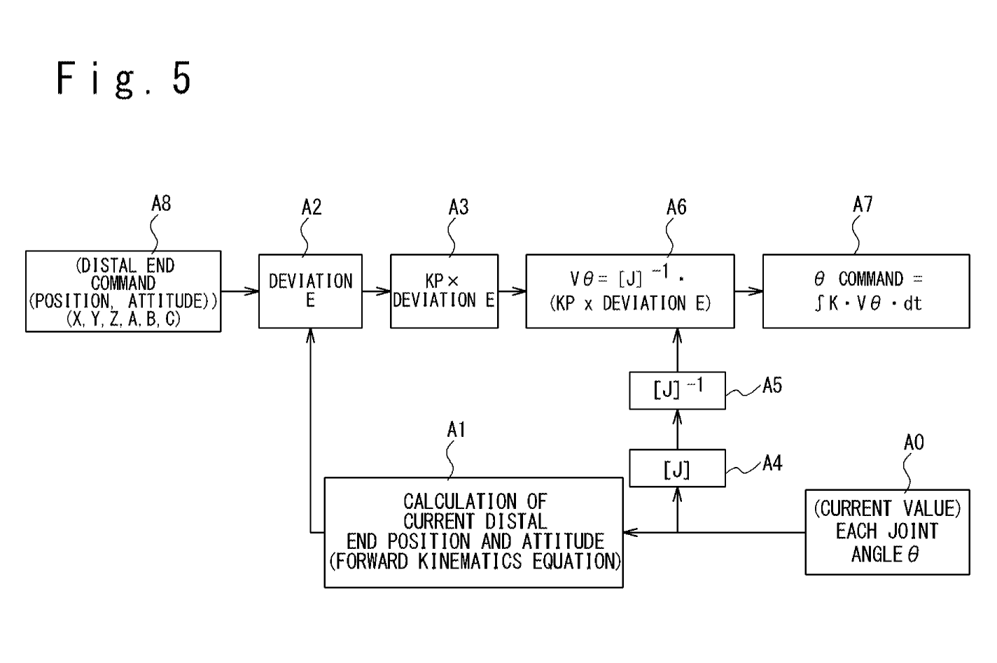

FIG. 5 shows a general flow of calculation in case of control of the joints J1 to J6 when the command value of the distal end 5 is inputted. The multi-joint manipulator 1 can detect the joint angle θ indicating the current attitude of each of the joints J1 to J6 by an encoder and so on. The detection value of the joint angle θ of each of the joints J1 to J6 is acquired from the multi-joint manipulator 1 by the computer D1 (A0). The computer D1 carries out forward kinematics calculation based on the joint angle θ and previously stored link parameters (length of each link and so on) to determine the current distal end position in the world coordinate system and the current distal end attitude (A1).

On the other hand, the operator uses the computer D1 to input the distal end command indicating a final target position and a final target attitude of the distal end 5 while viewing the simulation image of the display device D2. The computer D1 generates trajectory data indicating a trajectory from the current position and the current attitude to the final target position and the final target attitude with respect to the distal end 5 of the multi-joint manipulator 1. Note that the trajectory may include data indicating a time change of position of the distal end and data indicating a time change of attitude of the distal end. A command value of the position and attitude of the distal end (distal end command value) as a target in the next control period is issued to the current distal end 5 based on the trajectory data (A8). The computer D1 calculates a deviation E (the deviation E contains a position deviation and an attitude deviation) of a command value of position and attitude of the distal end to the current position and current attitude of the distal end calculated in A1 (A2). The computer D1 multiplies the deviation E by a proportional gain KP for a predetermined set position and attitude control (A3).

A Jacobian matrix [J] is calculated which shows a relation between an angular velocity of the joint and a distal end velocity of the rectangular coordinate system based on a detection value of the current angle of each of the joints J1 to J6 (A4). Moreover, an inverse matrix [J]⁻¹ of the Jacobian matrix is calculated (a pseudo inverse matrix when the multi-joint manipulator 1 has redundant degrees of freedom) (A5). A command value of the joint angular velocity is calculated from the position and attitude deviation KP·E multiplied by the gain by using the inverse Jacobian matrix [J]⁻¹ (A6).

By integrating the command value of the joint angular velocity with respect to time, a command value of variation of angle of each of the joints J1 to J6 is calculated. A command value of the joint angle is obtained by adding the command value of variation of angle to the current value of angle of each of the joints J1 to J6 inputted in block A0 (A7). Note that “K” in A7 of FIG. 5 is a coefficient. For example, the coefficient is set to K=1 in a normal control. The computer D1 transmits the command value of joint angle to the multi-joint manipulator 1. An operation control apparatus of the multi-joint manipulator 1 controls a motor and so on of each of the joints J1 to J6 based on the command value. By the above control, the end effector 4 can be moved to take a target position and the target attitude specified by the operator.

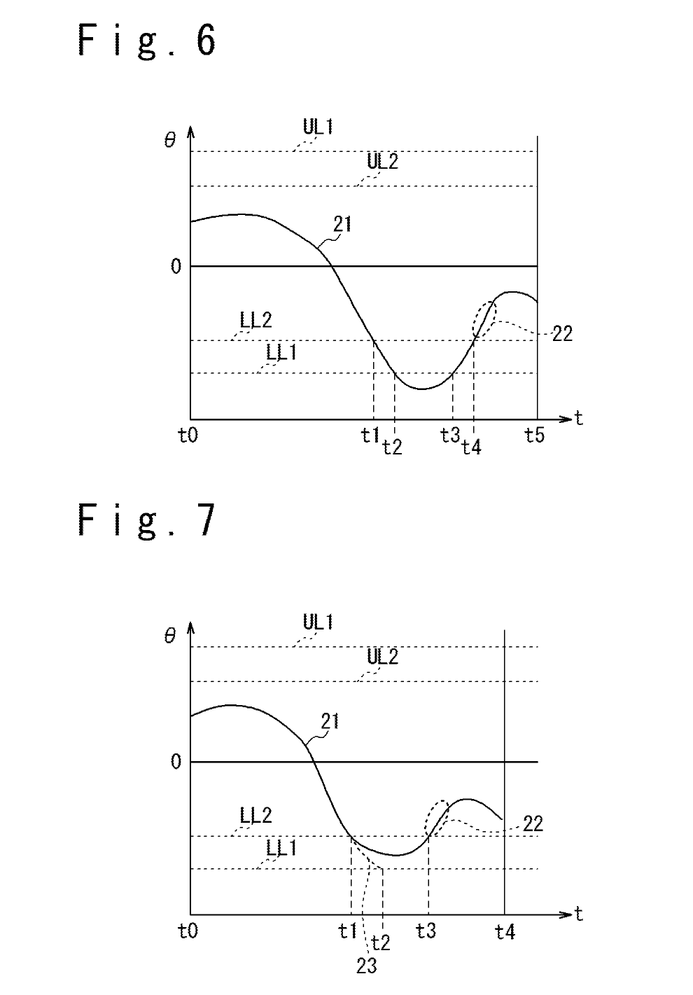

Next, a control near a movable limit of each of the joints J1 to J6 will be described in this embodiment. First, with reference to FIG. 6, a basic idea of control in this embodiment will be described. FIG. 6 shows a time change of a command value of angle θ1 when it is supposed that a movable range is not limited about some joint. However, actually, the movable range is supposed to be limited to a range between a lower limit LL1 and an upper limit UL1 in this joint. Virtual limits are set inside the range. That is, a virtual lower limit LL2 is set to a value higher than the lower limit LL1. A virtual upper limit UL2 is set to a value lower than the upper limit UL1. The virtual upper limit UL2 and the virtual lower limit LL2 are set for every joint according to the characteristic of each joint.

A command value is calculated through the forward kinematics calculation and the inverse kinematics calculation for control in a region where the angle 21 of the joint takes a value between the virtual upper limit UL2 and the virtual lower limit LL2, because there are excess widths to the actual upper limit UL1 and lower limit LL1.

In an example of FIG. 6, the angle 21 (the command value) falls below the virtual lower limit LL2 at time t1 and the angle 21 falls below the actual lower limit LL1 at time t2. After that, the angle 21 exceeds the actual lower limit LL1 at time t3 and returns to the movable range. Moreover, the angle 21 exceeds the virtual lower limit LL2 at time t4 and enters a safety region 22. Finally, when the distal end 5 reached a last target point at time t5, the angle 21 is inside the movable range.

In such a control, it is wanted to take some measure when the angle 21 of the joint approaches the upper limit UL1 or the lower limit LL1. Therefore, when the angle 21 falls below the virtual lower limit LL2 or exceeds the virtual upper limit UL2, a fault avoidance control is carried out. For example, in FIG. 6, because the angle 21 falls below the virtual lower limit LL2 at time t1, the control is changed from a normal control (non-fault avoidance control which is a control except for the fault avoidance control) to the fault avoidance control.

FIG. 7 shows an example of the change of the angle 21 in the fault avoidance control. A change rate of the angle command value of the joint approaching the limit is made small at the time t1 at which the fault avoidance control is started. At this time, the normal control is continued to the other joints. The angle 21 from time t1 of FIG. 7 shows a control result based on such an angle command value. As a result of such a control, a margin in time is generated until the angle 21 approaches the lower limit LL1.

In FIG. 7, an angle 23 shown by a dotted line is an angle change when the normal control is continued from time t1. In this case, the angle 23 of the joint reaches the lower limit LL1 at time t2 and the operation of the multi-joint manipulator 1 has stopped. However, because the change rate of angle of the joint is decreased when the fault avoidance control is applied, there is a margin until reaching the lower limit LL1 even at time t2. In such a state, the attitude of the multi-joint manipulator 1 changes because the other joints rotate. As a result, because the angle command value is changed to the joint to which the fault avoidance control is carried out, there is a possibility to avoid the angle command value from reaching the limit. In an example of FIG. 7, the angle 21 of the joint goes away from the lower limit LL1 during a period of the fault avoidance control, and the angle 21 exceeds the virtual lower limit LL2 at time t3 and enters the safety region 22. At this time t3, the control of the joint is returned to the normal control from the fault avoidance control.

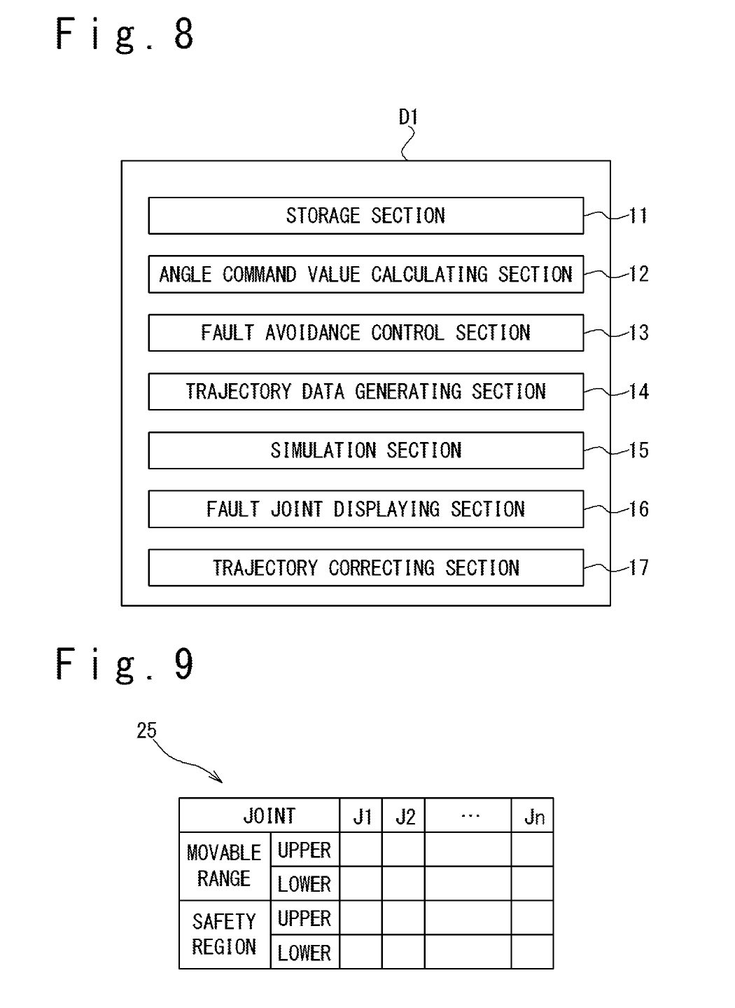

The above-mentioned fault avoidance control will specifically be described below. FIG. 8 is a functional block diagram implemented by the computer D1 carrying out the fault avoidance control. The computer D1 functions a storage unit 11, an angle command value calculating section 12, a fault avoidance control section 13, a trajectory data generating section 14, a simulation section 15, a fault joint displaying section 16, and a trajectory correcting section 17. Each of these functional blocks can be implemented by the processing unit of the computer D1 reading a software program stored in the non-transitory recording medium and executing it.

That is, the computer D1 (more specifically, the processing unit of the computer) carries out trajectory data generation processing, angle command value calculation processing, virtual limit determination processing, simulation processing, limit determination processing, trajectory correction processing, fault joint display processing and so on, by executing the above-mentioned program.

FIG. 9 shows a safety region table 25 stored in the storage unit 11. About each of the n joints J1, J2 . . . Jn of the multi-joint manipulator 1, the upper limit and the lower limit (actual limits) of the movable range, and the upper limit and the lower limit of the safety region 22 are registered. The safety region 22 may be registered only about a part of the joints J1, J2, . . . , Jn to apply to the fault avoidance control. The movable range may be registered based on not the upper limit and the lower limit but a pair of a limit angle in a right rotation direction and a limit angle in a left rotation direction.

### [Step S1: Trajectory Data Entry]

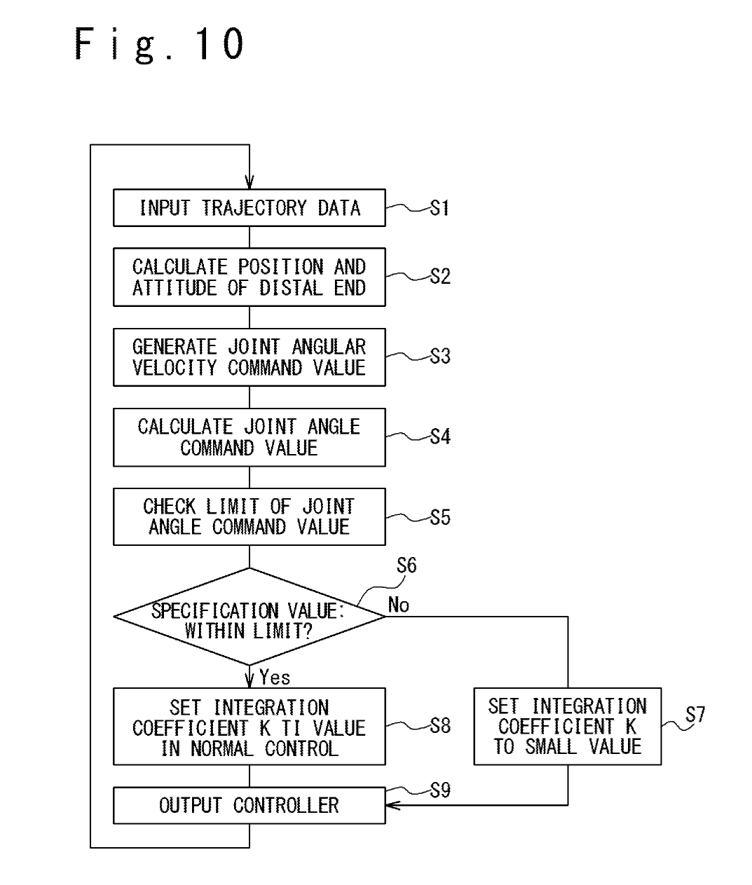

FIG. 10 is a flow chart of the fault avoidance control. The trajectory data generating section 14 carries out the trajectory data generation processing of generating the trajectory data indicating a command value of position and attitude of the distal end 5 of the multi-joint manipulator 1. The trajectory data is used to move the distal end of the multi-joint manipulator 1 from a current distal end position to a target distal end position along a predetermined trajectory (e.g. uniform linear movement). For example, such trajectory data is given as a command value of position and attitude of the distal end 5 of the multi-joint manipulator 1 for every control period. The computer D1 inputs the trajectory data generated in this way, when controlling the multi-joint manipulator 1.

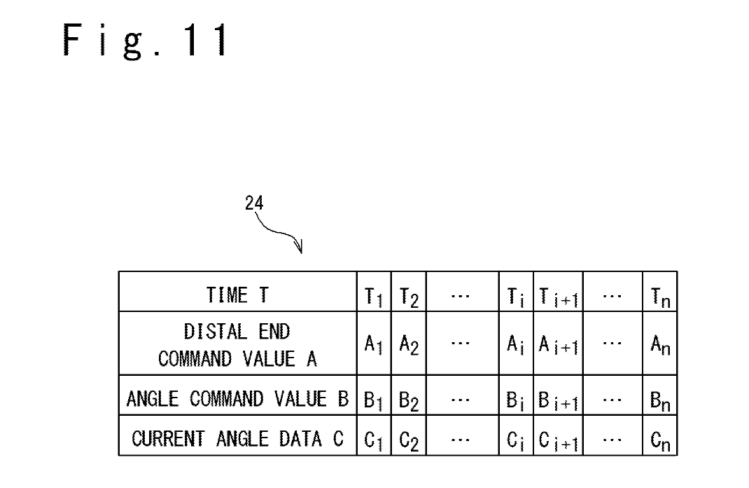

FIG. 11 shows a data table 24 showing data used in the control of this embodiment. Such a data table 24 may be stored in the storage unit 11. In the data table 24, the distal end command values A1 to An show the trajectory data (the distal end position command values showing the positions of the distal end at least, and more generally, the distal end position command values showing the positions and attitudes of the distal end). The trajectory data has a series of distal end position command values Ai (i is an integer equal to or more than 1 and equal to and less than n) from the distal end command value A1 at the first time T1 near the current distal end position to the distal end command value An at the n^{th} time Tn near the target distal end position. Each distal end command value Ai contains three values indicating position (X, Y, Z) and three values indicating attitude (A, B, C and indicate angles in the three-dimensional space which are expressed the Eulerian angle and so on).

### [Step S2: Calculation of Current Position and Attitude of Distal End]

A detection device such as an encoder which detects a rotation angle and so on is attached to each of the joints J1 to J6 of the multi-joint manipulator 1. The computer D1 reads the detection value of the rotation angle of each of the joints J1 to J6 from the multi-joint manipulator 1 in realtime (e.g. in the period of 10 ms). The detection value of this angle is shown as the current angle data C1 to Cn indicating the current angle of each of the plurality of joints in the data table 24.

The angle command value calculating section 12 carries out the calculation of a joint angle command value by a method shown in FIG. 5, to step S4 (in other words, the angle command value calculating section 12 carries out the angle command value calculation processing of calculating the joint angle command value). First, the current position of the distal end 5 of the multi-joint manipulator 1 is calculated from the detection value of the joint angle which is read from the multi-joint manipulator 1 through the forward kinematics calculation. The angle command value calculating section 12 calculates the current attitude of a link of the distal end 5 (the link L6 having the end effector 4 in FIG. 4). These are equivalent to the processing of A1 of FIG. 5.

### [Step S3: Calculation of Joint Angular Velocity Command Value]

An angular velocity command value Vθ (unit is radian per second [rad/s]) indicating a rotation velocity to each of the joints J1 to J6 is calculated by carrying out calculation of A2 to A5 in FIG. 5 based on the trajectory data command value inputted at step S1 and the current value of position and attitude of the distal end 5 generated at step S2. This processing is equivalent to A6 of FIG. 5.

### [Step S4: Calculation of Joint Angle Command Value]

The command value δθ [rad] of variation of the joint angle in the next control period is calculated by integrating with respect to time, a product of the joint angular velocity command value Vθ of each of the joints J1 to J6 and the coefficient K as in A7 of FIG. 5. The angle command value θ [rad] of each of the joints is generated by adding the command value δθ of variation of angle to the current value of angle of each of the joints J1 to J6 inputted at step S2. This angle command value θ is shown as an angle command value Bi at each time Ti in the data table 24 of FIG. 11. For example, the coefficient K used in the normal control (non-fault avoidance control) is set to K=1.

[Step S5: Check Virtual Limit with of Joint Angle Command Value]

The fault avoidance control section 13 carries out virtual limit determination processing of determining whether the angle command value calculated at step S5 for each of the joints J1 to J6 falls within a range between the virtual limits (the range between virtual lower limit LL2 and the virtual upper limit UL2). This determination is carried out by using values of the safety region of each of the joints J1 to Jn registered on the safety region table 25. Alternately, as another method, the determination may be carried out to have entered a range between the virtual limits, by using the upper limit and lower limit of the movable range of each of the joints J1 to Jn registered on the safety region table 25, when the angle command value of each of the joints has entered a predetermined range which is near the upper limit or the lower limit in the movable range (for example, a predetermined range where a margin to the upper limit is within 10 percent of the whole movable range, or a predetermined range where a margin to the lower limit is within 10 percent of the whole movable range).

### [Step S6: Branch Processing Based on Command Value]

When the angle command values to all the joints J1 to J6 are within the virtual limit (Step S6: Yes), the control advances to step S8 to carry out the normal control to all the joints J1 to J6 (in other words, non-fault avoidance control). When the angle command value corresponding to either joint of the joints J1 to J6 exceeds the virtual limit, the joint is determined to be a stop joint candidacy which has a possibility to be stopped. To carry out the fault avoidance control to the stop joint candidacy, the processing advances to step S7.

### [Step S7: Setting Integration Coefficient of Fault Avoidance Control]

The fault avoidance control is applied to the joint, the angle command value of which is determined to be outside the virtual limit in step S6. Specifically, the integration coefficient K used in the calculation of step S4 is made small (decreased). For example, K is set to K=0.1. In other words, the value (e.g. K=0.1) of the coefficient to be used in the fault avoidance control is smaller than the value (K=1) of the coefficient to be used in the normal control. The normal control is continued to the other joints. By such a setting, a rate when the rotation angle of the joint calculated at step S4 (A7 of FIG. 5) approaches a limit becomes small, so that the control can be realized as in the angle 21 in the period t1 to t3 of FIG. 7.

### [Step S8: Setting of Integration Coefficient of Normal Control]

Supposing that the coefficient used in the integration to generate a joint angle command value at step S5 is K, K is set to a value of the normal control (ex.: K=1). The value of K=1 is not changed to the joint to which the normal control has been carried out until the previous control period. The value of the integration coefficient is returned from the value (ex.: K=0.1) at the time of the fault avoidance control to the value K=1 at the time of the normal control when the current new angle command value is determined to fall within the virtual limit at step S7 with respect to the joint to which the fault avoidance control has been carried out until the previous control period.

### [Step S9: Output Command Value to Controller]

The computer D1 outputs the angle command value of each of the joints J1 to J6 calculated at step S4 to the multi-joint manipulator 1. The controller of the multi-joint manipulator 1 controls the angles of the joints J1 to J6 by using the angle command values.

### [Simulation of Operation of Multi-Joint Manipulator]

Next, the simulation of the operation of the multi-joint manipulator 1 will be described. In the above-mentioned FIG. 10, the control when the joint approaches a limit during an operation of an actual machine of the multi-joint manipulator 1 has been described. On the other hand, it is possible to virtually realize the operation of the multi-joint manipulator 1 through the simulation when the joint approaches a limit without being accompanied by the operation of the actual machine.

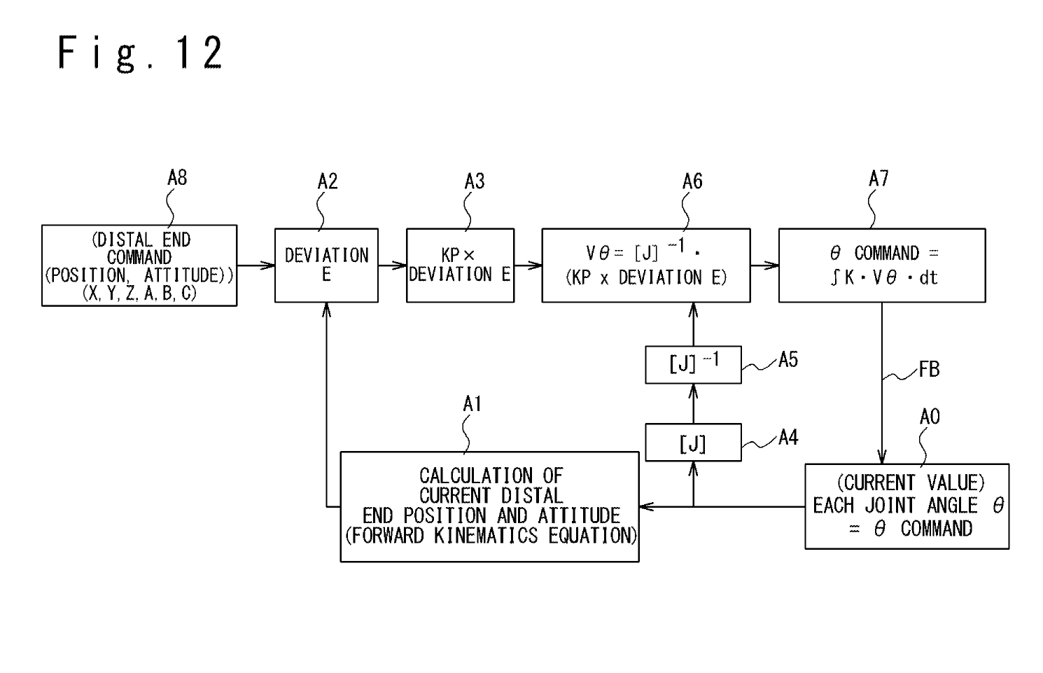

The simulation section 15 of FIG. 8 carries out simulation processing of virtually realizing the operation of the multi-joint manipulator 1 through the simulation. In other words, the computer D1 executes a program stored in the recording medium (a storage unit) to function as a simulation apparatus to virtually realize the operation of the multi-joint manipulator 1 through the simulation. Referring to FIG. 12, simulation processing realized by a simulation section (the simulation apparatus) will be described. The following two points are different from FIG. 5.

(1) Feedback processing FB is added in which the angle command value θ of the joint generated in block A7 is fed back as the current value θ of each joint angle.
(2) The current value of angle of each of the joints J1 to J6 is acquired from the actual machine of the multi-joint manipulator 1 in block A0 of FIG. 5. Instead of it, in block A9 of FIG. 12, the command value θ of joint angle calculated in block A7 is given as the command value θ of each joint angle at time Ti+1, by using a distal end command value and the angle command value θ of each joint at time Ti.

The difference between the calculations in FIG. 5 and FIG. 12 has the following meaning. (a) In FIG. 5, by the calculation at time Ti, the command value of joint angle is generated in the block A7, and the multi-joint manipulator 1 is controlled based on the command value. A detection value of each joint angle obtained as the result of the control is used for the control calculation at the next time Ti+1.

(b) On the other hand, in FIG. 12, the θ command is updated in a pseudo manner and is uses as the current value θ at the next time and the convergence calculation of the Jacobian matrix is carried out. Through such a calculation, the operation of the multi-joint manipulator 1 is realized in the pseudo manner in the computer D1.

Such a simulation can be carried out as follows by referring to the data table 24 of FIG. 11. The simulation section 15 uses the distal end command values A1 to An in order and carries out the implementation of the operation of the multi-joint manipulator. Moreover, the simulation section 15 acquires the angle command value Bi of each of the joints at time Ti as the calculation result based on the distal end command value Ai in the angle command value calculating section. By setting the angle command value Bi as current angle data Ci+1 of each of the joints at the next time Ti+1, the feedback processing FB of FIG. 12 is carried out.

By such a simulation, the operation of the distal end 5 of the multi-joint manipulator 1 from the current position and attitude to a final target position and attitude can be realized virtually and approximately. Therefore, it is possible to confirm whether or not there is a possibility that each of the joints steps out from the movable range in case of the operation.

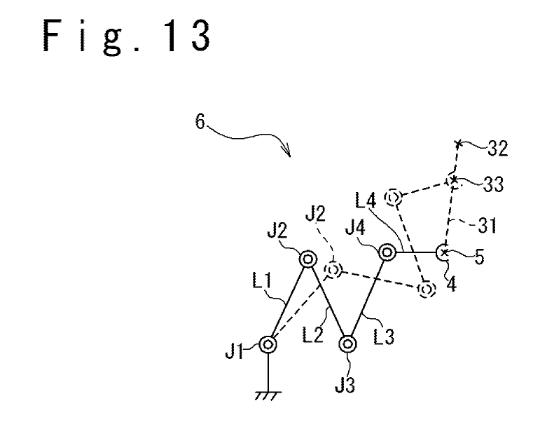

FIG. 13 shows an example of the multi-joint manipulator image 6 which is calculated by the computer D1 and is displayed on the display device D2. The solid line shows the start point of the control and the dotted line shows the multi-joint manipulator image 6 in the middle of the control. In the start point of the control, the position and attitude of the distal end 5 are given. Moreover, the final target position which is the position of the distal end in the target point 32 and the final target attitude which is the attitude of the distal end in the target point are set. Moreover, the trajectory 31 which connects the start point and the target point 32 is set.

The computer D1 carries out the simulation shown in FIG. 12 by using these settings and data defining the multi-joint manipulator 1 such as the movable range of each of the joints J1 to J4 and the link parameter. As a result, the movement of the multi-joint manipulator 1 when the distal end 5 moves along the trajectory 31 to the target point 32 can be realized virtually.

In such a simulation, the determination of whether or not the joint reached the limit of the movable range is carried out (in other words, the simulation section 15 carries out the limit determination processing of determining whether or not at least one of the plurality of joints reached the limit of the movable range). The fault joint displaying section 16 of FIG. 8 determines whether or not each of the joints J1 to J4 falls within the movable range in case of simulation of the multi-joint manipulator 1. When falling within the movable range, the simulation is continued. When the angle command value of either of the joints J1 to J4 (the angle command value Bi of FIG. 11) exceeds the movable range, it is determined that a fault joint has occurred. When the fault joint has occurred, the simulation is stopped and the multi-joint manipulator image 6 at the time Ti is displayed. The dotted line in FIG. 13 shows the multi-joint manipulator image 6 in the condition that the simulation is stopped because the joint (e.g. joint J2) exceeded the movable range when the distal end reached a stop point 33.

It is possible to virtually realize fault avoidance processing described with reference to FIG. 10 in such a simulation.

### [Trajectory Correction Processing]

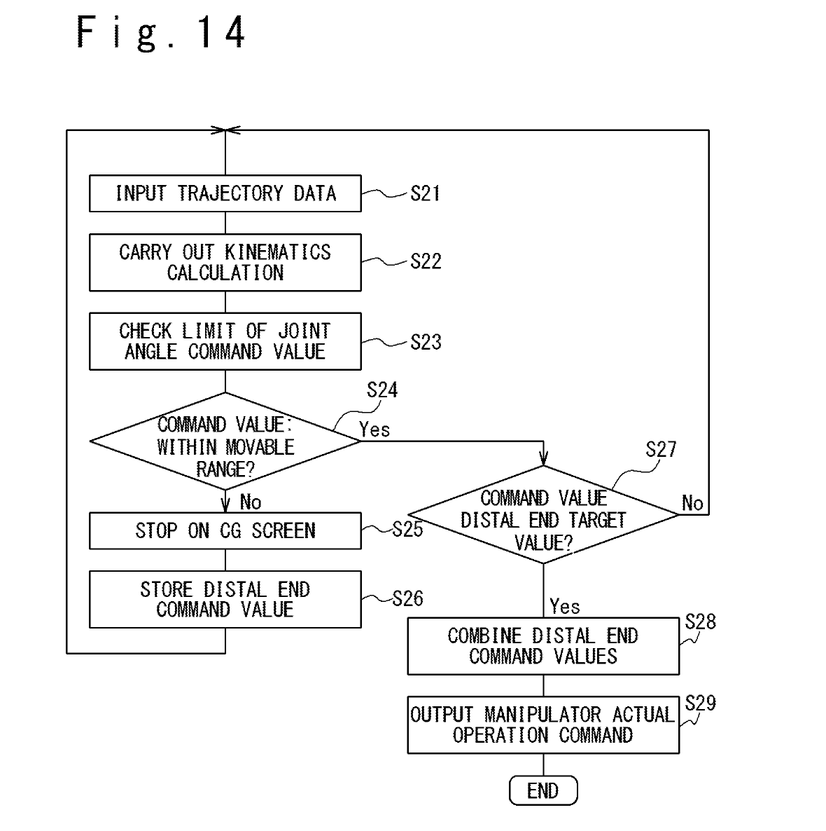

In such a simulation, it is wanted that when the angle of either of the joints J1 to J4 exceeds the movable range, the trajectory 31 is corrected so that the angles of all the joints J1 to J4 fall within the movable range. FIG. 14 is a flow chart showing a simulation method of the multi-joint manipulator 1, and the trajectory correction processing (the trajectory correction processing carried out by trajectory correcting section 17).

Like step S1 of FIG. 10, the trajectory data generating section 14 carries out the trajectory data generation processing of generating the trajectory data (Step S21). Like steps S2 to S4 of FIG. 10, an angle command value of each of the joints J1 to J4 is calculated (angle command value calculation processing is carried out) by the kinematics calculation. However, the angle command value is calculated by using the current value of the joint angle acquired from the actual machine in case of FIG. 10, whereas the operation of the multi-joint manipulator 1 is realized in pseudo manner and is displayed as the operation of the multi-joint manipulator image 6 by a method shown in FIG. 12 in case of FIG. 14 (Step S22).

The simulation section 15 determines whether or not the angle command value calculated at step S22 to each of the joints J1 to J4 falls within the movable range (in other words, the simulation section 15 carries out the limit determination processing of determining whether or not at least one of the joints reached the limit of the movable range). This determination is carried out by using the upper limit and lower limit of the movable range registered on the safety region table 25 (Step S23).

When the angle command value falls within the movable range as for each of the joints J1 to J4 (step S24: Yes), the processing advances to step S27. When the angle command value Bi of either of the joints J1 to J4 at time Ti exceeds the movable range, the processing advances to step S25 (Step S24: No).

### [Step S25: Stop on CG Screen]

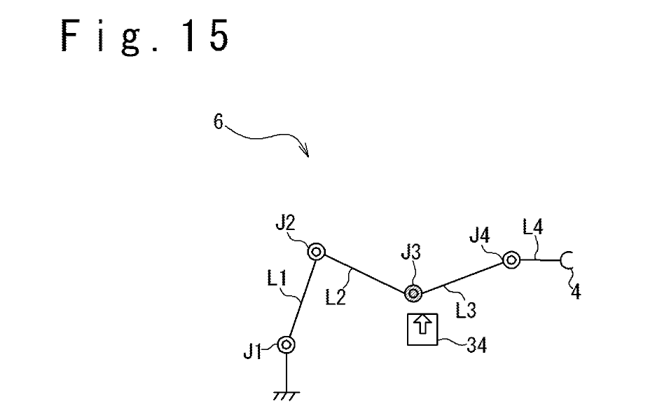

When the angle command value Bi of either of the joints J1 to J4 exceeds the movable range, the simulation is stopped and the multi-joint manipulator image 6 at the point is displayed. FIG. 15 shows a display example when the angle command value Bi of the joint J3 exceeds the upper limit. The fault joint displaying section 16 carries out a fault joint display to show the joint on the screen in order to make it easy to find the joint J3 reached a limit in the angle (in other words, the fault joint displaying section 16 carries out the fault joint display processing to indicate the joint reached the limit in the angle). For example, the display is carried out to distinguish the fault joint from the other joints (for example, the display is carried out with different colors). Moreover, a fault direction display is carried out to show a direction of one side or the other side when the angle of the fault joint J3 exceeded the limit of the movable range. In an example of FIG. 15, as a fault direction display, a lower limit display 34 is carried out to show a downward arrow when the angle of the joint (e.g. the joint J3) reaches the lower limit, and an upper limit display 34 is carried out to show an upward arrow when the angle of the joint (e.g. the joint J3) reaches the upper limit.

### [Step S26: Storage of Distal End Command Value]

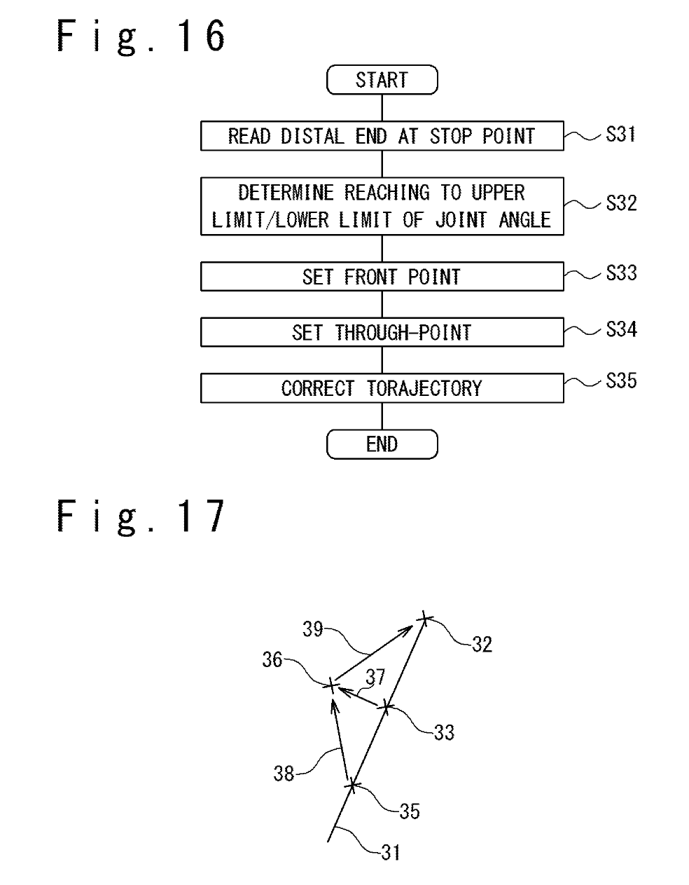

Next, the distal end command value of the joint J3, the angle of which reached a limit, is corrected to go away from the limit, that is, to head for the center of the movable range and is stored. Specifically, the correction is carried out so that the angle of the joint J3 falls within the movable range, by setting a new through-point on the trajectory of the distal end. FIG. 16 is a flow chart of such through-point setting processing (note that the through-point setting processing is carried out by the trajectory correcting section 17 of the computer D1). First, the distal end position at a stop point 33 is read (Step S31). Next, whether the angle of the joint J3 is in the lower limit of the movable range or in the upper limit thereof is determined (Step S32).

Next, a front point 35 is set as exemplified in FIG. 17. For example, when the simulation stops based on the angle command value Bi at time Ti, the front point 35 is set by the distal end command value Ai-k at time Ti-k (k is an integer equal to or more than 1) earlier by a predetermined period than the time Ti (Step S33).

Next, a through-point 36 is set. The through-point 36 is set for the joint J3 reached the limit at the stop point 33 (the direction 37 of the leaving of FIG. 17) to take a direction away from the limit, compared with the trajectory 31 before the correction.

For example, when an angle of the joint J3 has reached the upper limit at the time that the distal end 5 is situated on a stop point 33, a through-point 36 is set to a position of the distal end 5 when the angle of the joint J3 is made smaller by a predetermined angle A in the condition that the other joints J1, J2, and J4 are fixed (for example, fixed on the angles of the joints J1, J2, and J4 in the stop point 33) (Step S34). The corrected trajectory is generated by connecting the front point 35 and the through-point 36 by the trajectory 38 such as a straight line, by connecting the through-point 36 and the target point 32 in the trajectory 39 such as the straight line. The setting of such a through-point 36 (step S35) may be automatically carried out by the trajectory correcting section 17 and at least a part of the setting may be carried out by the input operation by the operator (for example, the setting of the through-point 36 may be implemented by the input operation by the operator).

The trajectory correcting section 17 stores the distal end command values of the corrected trajectories 38 and 39 (step S26 of FIG. 14). The above trajectory correction processing is carried out every time either of the joints J1 to J4 reaches the limits. Therefore, two or more through-points 36 are sometimes set.

When the corrected trajectory is generated, processing from step S21 is repeated. However, the following calculation is carried out by using the corrected trajectory in the condition that the position has been returned to the trajectory 31 at the time of the front point 35.

Returning to FIG. 14, when the angle command values of all the joints J1 to J4 fall within the movable range at step S24 (Step S24: Yes), whether or not the distal end 5 has reached the target point 32 (the final distal end target value) is determined (Step S27). When the distal end 5 has not reached the target point 32, processing from step S21 is repeated (Step S27: No). When the distal end 5 has reached the target point 32 (step S27: Yes), the processing advances to step S28.

When the trajectory correction is carried out at step S26, the distal end command value is generated to show the corrected trajectory, by connecting the trajectories which passes through the through-point 36 (in an example of FIG. 17, a trajectory 31 to the front point 35, and trajectories 38 and 39 from the front point 35) (Step S28).

The computer D1 transmits the distal end command value to the multi-joint manipulator 1 (actually existing multi-joint manipulator) as an actual operation command (Step S29). Because the distal end command value is corrected in the simulation so that each of the joints J1 to J4 does not exceed the movable range, there is a high probability that the distal end 5 can reach the target point 32 without stopping of the operation of the actual machine.

The fault avoidance processing described with reference to FIG. 10 can be applied to the trajectory correction processing described with reference to FIG. 14. In this case, the determination at steps S5 and S6 of whether the joint angle command values are in a range between the virtual limits is carried out before the determination at step S23 of whether or not the joint angle command values fall within the movable range. When any of the joint angle command values exceeds the range between the virtual limits, the fault avoidance processing at step S7 is carried out. After that, processing from step S23 is carried out.

Through such processing, when the angle of either of the joints approaches the virtual limit, the fault avoidance processing is executed first. However, only when the joint reaches an actual limit, the trajectory correction processing at step S26 is carried out. Therefore, the number of times of execution of the trajectory correction processing reduces and the distal end 5 can be led to the target point 32 in a natural route which is near the original trajectory.

The present invention is not limited to each of the above embodiments. It would be apparent that each embodiment can be changed or modified appropriately in the range of the technical thought of the present invention. Also, various techniques used in each embodiment or a modification example can be applied to another embodiment and another modification example in a range with no technical contradiction.

This application is based on Japanese Patent Application (JP 2014-52546) filed on Mar. 14, 2014 and claims a priority based on it. The disclosure of the Patent Application is incorporated herein by reference.

1. A simulation apparatus of a multi joint manipulator having a plurality of joints, comprising:
a display section which visibly provides data;
a storing section which stores a software program and stores a movable range of angle of each of the plurality of joints and a safety region defined within the movable range in the storage unit; and
a processing unit which executes the software program to implement a processing section which comprises:
an angle command value calculating section which generates an angle command value for each of the plurality of joints, based on current angle data indicating a current angle of each of the plurality of joints and a distal end position command value of the multi-joint manipulator, and which carries out a fault avoidance control to make a change rate of the angle command value small, when the angle command value is generated to a stop joint candidacy which is either of the plurality of joints and the angle command value of which exceeds the safety region,
wherein the processing section outputs data showing the processing result to the display section such that an operation of the multi joint manipulator is virtually realized.

2. The simulation apparatus according to claim 1, wherein the angle command value calculating section generates the angle command value by integrating a product of a command value of an angular velocity of each of the plurality of joints and a coefficient with respect to time, and
wherein a value of the coefficient to be used in the fault avoidance control is smaller than the value of the coefficient to be used in a control except for the fault avoidance control.

3. The simulation apparatus according to claim 1, wherein the processing section further comprises:
a trajectory data generating section which generates trajectory data used to move the distal end of the multi joint manipulator from a current distal end position to a target distal end position along a predetermined trajectory, wherein the trajectory data comprises a series distal end position command value Ai (i is an integer equal to or more than 1 and equal to or less than n) from a distal end position command value A1 at a first time T1 when the distal end is near the current distal end position to a distal end position command value An at an n^{th} time Tn when the distal end is near the target distal end position,
wherein the operation of the multi joint manipulator is virtually realized by using the distal end position command values A1 to An,
wherein the simulation section obtains an angle command value Bi at time Ti of each of the plurality of joints as a calculation result of the angle command value calculating section which is based on the distal end position command value Ai, and sets the angle command value Bi as the current angle data Ci+1 of each of the plurality of joints at a next time Ti+1.

4. The simulation apparatus according to claim 3, wherein the processing section further comprises:
a fault joint displaying section which displays a simulation image showing the multi joint manipulator at time Ti, when the angle command value Bi of either of the plurality of joints as a fault joint exceeded the movable range in the virtual realization, and carries out a fault joint display indicating the fault joint in the simulation image.

5. The simulation apparatus according to claim 4, wherein the movable range is defined based on one end and the other end, and
wherein the fault joint displaying section carries out a fault direction display indicating which of the one end and the other end the fault joint exceeded.

6. The simulation apparatus according to claim 3, wherein the processing section further comprises:
a trajectory correcting section which corrects the trajectory data when the angle command value Bi exceeds the movable range,
wherein in the correction, the distal end position command value Ai−k at time Ti−k (k is an integer equal to or more than 1) before the time Ti is corrected such that the angle of the joint, which exceeded the movable range, of the plurality of joints become near to a center of the movable range, compared with a state before the correction is carried out.

7. A control unit which controls a multi-joint manipulator having a plurality of joints, comprising:
a storing section which stores a software program and stores a movable range of angle of each of the plurality of joints and a safety region defined within the movable range in the storage unit; and
a processing unit which executes the software program to implement a processing section which comprises:
an angle command value calculating section which generates an angle command value for each of the plurality of joints, based on current angle data indicating a current angle of each of the plurality of joints and a distal end position command value of the multi joint manipulator, and which carries out a fault avoidance control to make a change rate of the angle command value small, when the angle command value is generated to a stop joint candidacy which is either of the plurality of joints and the angle command value of which exceeds the safety region,
wherein the processing section controls the multi joint manipulator based on the generated angle command values data.

8. A robot system comprising:
a multi joint manipulator having a plurality of joints;
a storing section which stores a software program and stores a movable range of angle of each of the plurality of joints and a safety region defined within the movable range in the storage unit; and
a processing unit which executes the software program to implement a processing section which comprises:
an angle command value calculating section which generates an angle command value for each of the plurality of joints, based on current angle data indicating a current angle of each of the plurality of joints and a distal end position command value of the multi joint manipulator, and which carries out a fault avoidance control to make a change rate of the angle command value small, when the angle command value is generated to a stop joint candidacy which is either of the plurality of joints and the angle command value of which exceeds the safety region,
wherein the processing section controls the multi joint manipulator based on the generated angle command values data.

9. A simulation method of a multi joint manipulator having a plurality of joints, comprising:
providing in a storage unit, a movable range of angle of each of the plurality of joints and a safety region defined within the movable range;
generating, by a processing unit, an angle command value of each of the plurality of joints based on current angle data indicating current angle of each of the plurality of joints and a distal end position command value of the multi joint manipulator;
wherein the generating an angle command value comprises:
carrying out a fault avoidance control to make a change rate of the angle command value small, when the angle command value for one of the plurality of joints as a stop joint candidacy exceeds the safety region; and
virtually displaying an operation of the multi joint manipulator based on the generated angle command values.

10. The simulation method according to claim 9, wherein the generating an angle command value comprises:
generating the angle command value by integrating a product of a command value of an angular velocity of each of the plurality of joints and a coefficient with respect to time, and
wherein a value of the coefficient to be used in the fault avoidance control is smaller than the value of the coefficient to be used in a control except for the fault avoidance control.

11. The simulation method according to claim 9 or 10, further comprising:
generating trajectory data used to move the distal end of the multi-joint manipulator from a current distal end position to a target distal end position along a predetermined trajectory, wherein the trajectory data comprises a series distal end position command value Ai (i is an integer equal to or more than 1 and equal to or less than n) from a distal end position command value A1 at a first time T1 when the distal end is near the current distal end position to a distal end position command value An at an n^{th} time Tn when the distal end is near the target distal end position; and
implementing virtual realization of an operation of the multi-joint manipulator by using the distal end position command values A1 to An in order,
wherein the implementing virtual realization comprises:
obtaining an angle command value Bi at time Ti of each of the plurality of joints as a calculation result of the angle command value calculating section which is based on the distal end position command value Ai; and
setting the angle command value Bi as the current angle data Ci+1 of each of the plurality of joints at a next time Ti+1.

12. A method of controlling a multi joint manipulator having a plurality of joints, comprising:
providing in a storage unit, a movable range of angle of each of the plurality of joints and a safety region defined within the movable range;
generating, by a processing unit, an angle command value of each of the plurality of joints based on current angle data indicating current angle of each of the plurality of joints and a distal end position command value of the multi joint manipulator;
carrying out a fault avoidance control for the multi-joint manipulator to make a change rate of the angle command value small, when the angle command value for one of the plurality of joints as a stop joint candidacy exceeds the safety region; and
controlling the multi joint manipulator based on the generated angle command values data.

13. (canceled)
